(19) United States
(12) Patent Application Publication
(10) Pub. No.: US 2018/0025358 A1
(43) Pub. Date: Jan. 25, 2018

(54) MOBILE REAL-TIME SHARING SECURITY MANAGEMENT SYSTEM

(71) Applicant: Tae Sik YOON, Yongin-si, Gyeonggi-do (FR)

(72) Inventor: Tae Sik YOON, Yongin-si, Gyeonggi-do (KR)

(21) Appl. No.: 15/542,221

(22) PCT Filed: Apr. 11, 2016
(86) PCT No.: PCT/KR2016/003770

§ 371 Date: Jul. 7, 2017

(30) Foreign Application Priority Data
Jun. 3, 2015 (KR) 10-2015-0078313

(51) Int. Cl. G06Q 20/40; G06Q 20/38; G06Q 20/12

(52) U.S. Cl. CPC G06Q 20/40145; G06Q 20/12; G06Q 20/382; H04L 9/32

(57) ABSTRACT

The present invention relates to a security management system for a mobile phone that maximizes personal information security by separating a main storage device (memory) of the mobile phone into separate independent systems.

### TECHNICAL FIELD

The present invention relates to a security management system for enhancing the security level of mobile phone that is highly likely to be lost or stolen. More particularly, the present invention relates to a security management system for separating main storage device from a mobile phone, time-shared security management system (Thummin System) that maximizes level of security of the mobile phone.

### BACKGROUND TECHNOLOGY

Generally, mobile phones have been developed for the purpose of talking on the move, but the technology has made it possible for the Internet to be used, and it has been widely used in electronic financial transactions and mobile shopping. In addition, with the proliferation of computers and the rapid development of Internet technologies, the Internet has grown exponentially.

Currently, the Internet has been used as a channel for transmitting information such as products, services, and advertisements in a simple information exchange function. It is possible to purchase activities around the world without restriction of time and place, it is becoming an infrastructure of electronic commerce due to reduction of distribution and decrease of sales manpower. , in the case of accessing Internet site or requiring security in electronic commerce, safety in the authentication method is essential. In the conventional technology, when a user accesses the Internet through a computer, a public key and a private key for authentication are given. The user is authenticated using a password and a security card arbitrarily set.

However, all procedures for such authentication are performed through the connected Internet line.

However, since all the procedures for such authentication are made through connected Internet line, it is practically impossible to install a high security measure on all the lines connected to the public. The authentication procedure performed through such a general access network is basically exposed to the risk of hacking. That is, when authentication is required while using the Internet in a public PC environment, the user tends to avoid using identification authentication due to anxiety towards malicious codes such as keyboard scan or snapping and other various worm wares.

In addition, there is a waste of time and manpower required when a user purchases goods through e-commerce or requires settlement or authentication. It's cumbersome using an Internet service, and inputting records of his/her own information. Due to that reason users tend to avoid such work, and in result deterioration of online services.

On the other hand, a biometric system is one of the areas where security technologies of portable devices and the Internet have been getting popular. As such biometric identification methods, fingerprint recognition, iris recognition, vein recognition, and the like are typically used.

Although the biometric identification method may be more secure than other methods, the introduction price is relatively high. In addition, there are many difficulties in implementation due to lack of fast data transmission technology and authentication technology required for biometric system. In order for this method to be commercialized, a socio-economic network infrastructure capable of transmitting and receiving a large amount of information data in real time without delay is required.

For example, Korean Patent Laid-Open Publication No. 10-2011-0087810 discloses a client PC that receives user information and stores it in a database server via a web server, a mobile phone security management server for issuing the module, a web server for transmitting the security module to the mobile phone, and an access management terminal for transmitting the security module to the mobile phone and the mobile phone security management server. The registration number 10-0805767 includes a user terminal, a provider server, a PIM-Bank server, and a user mobile phone. When the mobile phone number is input to the PIM-Bank server, the application downloaded to the user mobile phone, authentication is performed and the authentication result is sent to the PIM-Bank server. Discloses a personal information management system using a mobile phone notified by a user.

However, conventional technologies including the above-described methods still provide security programs and applications such as a firewall to a mobile phone or a PC to protect personal information stored in a mobile phone or a PC. This results in a problem such as that if the above security programs are disabled, personal information can not be protected.

### DETAILED DESCRIPTION OF THE INVENTION

Technical Assignment

The present invention has been made to solve the above-mentioned problems and to supplement the conventional technologies. Main object of the present invention is to separate a main storage device (memory) of a cellular phone into separate independent systems, robots and autonomous vehicles, it can protect hacker's attacks in advance, can facilitate safe financial transactions, protect personal information in the event of loss or theft of mobile phones, and protect personal information embedded in a separate system. It is aimed to provide real-time shared security management system for mobile phones remotely.

Technical Solution

The thummin system 1 constituting the cellular phone real-time shared security management system and the present invention includes a biometric code data input unit 10, a biometric identification code data recognition unit 11, a biometric identification code data storage unit 12, A biometric identification code data such as the financial transaction data transmission unit 13, the biometric identification code data receiving unit 14, the biometric identification code and the account data recording unit 15, the financial account data input unit 20, a financial transaction data storing unit 22, a financial transaction result data transmitting unit 23, a financial transaction data receiving unit 24, a financial transaction data inquiry unit 25, a financial transaction result data receiving unit 26, a financial transaction result display section 27, and a financial transaction approval section 28.

Effects of the Invention

Since the mobile phone real-time shared security management system according to the present invention stores and manages a password stored in a separate system independent of the user, it is possible to completely protect personal information even in the event of loss or theft of a mobile phone device performing a remote control function. As an innovation that does not have to pay the high commission paid to banks, payment gateway (PG) and VAN companies by implementing electronic financial transactions (incoming, outgoing, remittance, debit and credit transactions). Since most IDs and passwords are not required for the digital era, it is possible to expect complete and easy security effects in both online and offline environments, as it can receive support from most merchants, and also in computers, Internet (IoT), robots, and autonomous vehicles.

### BRIEF DESCRIPTION OF THE DRAWINGS

FIG. 1 shows a Thummin system of a mobile phone real-time shared security management system according to the present invention.

FIG. 2 is a diagram of the Thummin system of a mobile phone real-time shared security management system according to the present invention.

FIG. 3 is a flow chart for inputting biometric information of a mobile phone real-time shared security management system according to the present invention.

FIG. 4 is a flow chart for inquiring biometric information and financial information of a mobile phone real-time shared security management system according to the present invention.

FIG. 5 is a financial transaction flowchart of a real-time shared security management system for mobile phones according to the present invention.

### BEST MODE FOR CARRYING OUT THE INVENTION

Detailed description of the preferred embodiments, hereinafter, will be described in detail with reference to the accompanying drawings and embodiments due to possibilities of unnecessary vagueness of explanation. In the following description of the present invention, a detailed description thereof has been omitted.

The following terms are defined in consideration of the functions of the present invention, and may be changed according to the intention of the user, the operator, or the like. Therefore, the definition should be based on the contents throughout this specification.

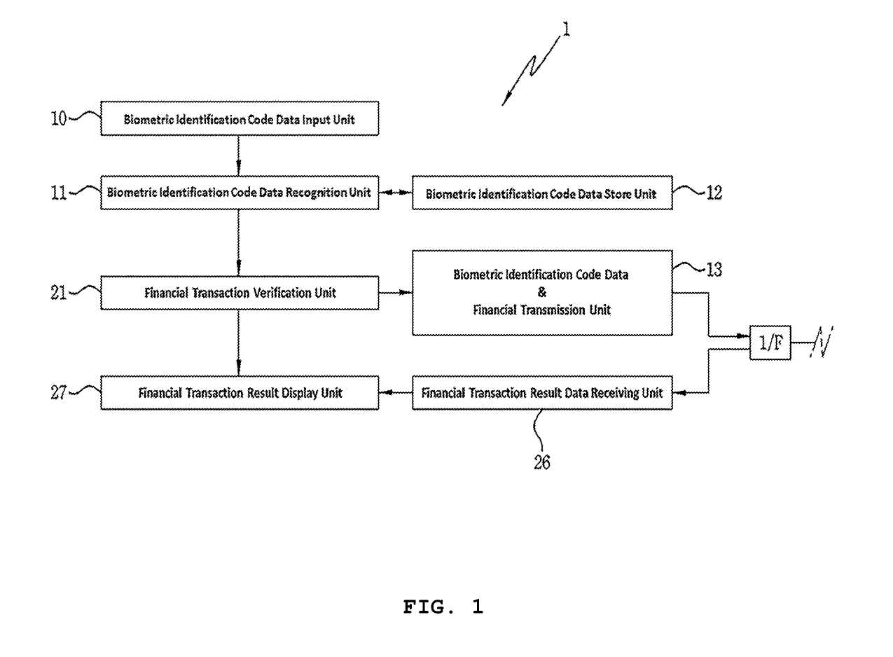

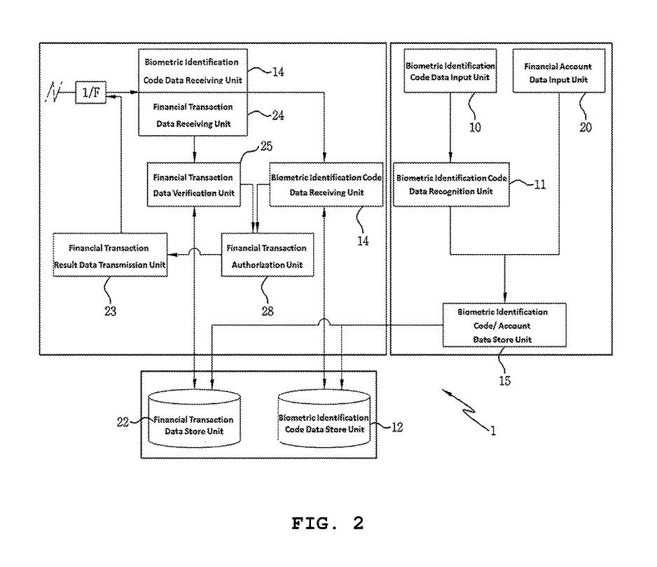

FIG. 1 is a block diagram of a Thummin system of a mobile phone real-time shared security management system according to the present invention. FIG. 2 is a diagram 2 of a Thummin system of a mobile phone real-time shared security management system according to the present invention. FIG. 1 and FIG. 2 to be explained in detail,

An identification code data input section 10, biometric identification code data recognition section 11, biometric identification code data storage section 12, biometric identification code data and a financial transaction data transmission section 13 An identification code data receiving unit 14, biometric identification code and an account data recording unit 15 and a part related to biometric identification code and a financial account data input unit 20, a financial account data recognition unit 21, The financial transaction data storage unit 22, the financial transaction result data transmission unit 23, the financial transaction data reception unit 24, the financial transaction data inquiry unit 25, the financial transaction result data reception unit 26, the financial transaction result display unit 27, And financial transaction approval section 28.

The user's personal bio-identification code is inputted using the keypad of the cellular phone or the camera, which is performed by the bio-identification code data input unit 10. It is possible to perform typing work such as a password by using the keypad of the mobile phone, input the fingerprint of the user by using the touch pad of the mobile phone, and display the biometric information of the appearance including the user's facial appearance by using the camera can be inputted.

When the bio-identification code is inputted, the bio-identification code data recognition unit 11 recognizes and identifies a normal bio-identification code. At this time, unnecessary biometric information or an identification code is deleted, and normal biometric information or an identification code is extracted. As described above, the biometric information or the identification code recognized by the biometric identification code data recognition unit 11 is stored in the biometric identification code data storage unit 12 constituting a separate management system with enhanced security through wire or wireless communication, it is safely stored.

Also, if the financial account data input unit 20, inputs personal financial information of an individual, using a cellular phone, biometric or the identification code is stored in both account data record unit ID code data storage unit 12 and the financial transaction data storage unit 22 securely storing transmitted data through Data Storage Unit 15.

When the biometric identification code data recognizing unit 11 recognizes the financial information of the individual in the financial transaction data recognizing unit 21, it displays the result of the financial transaction through the financial transaction result display unit 27. At the same time, transmits the biometric data, the identification code data, and the financial transaction data transmission unit 13, which are components of the mobile phone. The transmitted data is received by the bio-identification code data receiving unit 14 and the financial transaction data receiving unit 24 constituting a separate management system with enhanced security through wired or wireless communication, Stores it in the storage unit 12. At the same time, the financial transaction data inquiry unit 25 inquires financial transactions. Of course, the related data is safely stored in the financial transaction data storage unit 22.

The data transmitted through the financial transaction data inquiry unit 25 and the biometrics and identification code data receiving unit 14 are subjected to the approval by the financial transaction acceptance unit 28 and are transmitted to the financial transaction result data transmission unit 23. The data transmitted from the financial transaction result data transmission unit 23 is received by the financial transaction result data reception unit 26 which is a component of the mobile phone and is immediately outputted to the financial transaction result display unit 27 And notifies the user.

In this way, the cellular phone constituting the thummin system (1) is not constituted of a main storage device (memory), only a volatile auxiliary storage device (memory) is constituted so as to transmit and receive a minimum amount of data. This is because the mobile phone itself, which has the highest risk of being stolen or lost, does not have a main storage device (memory), thereby protecting personal information completely.

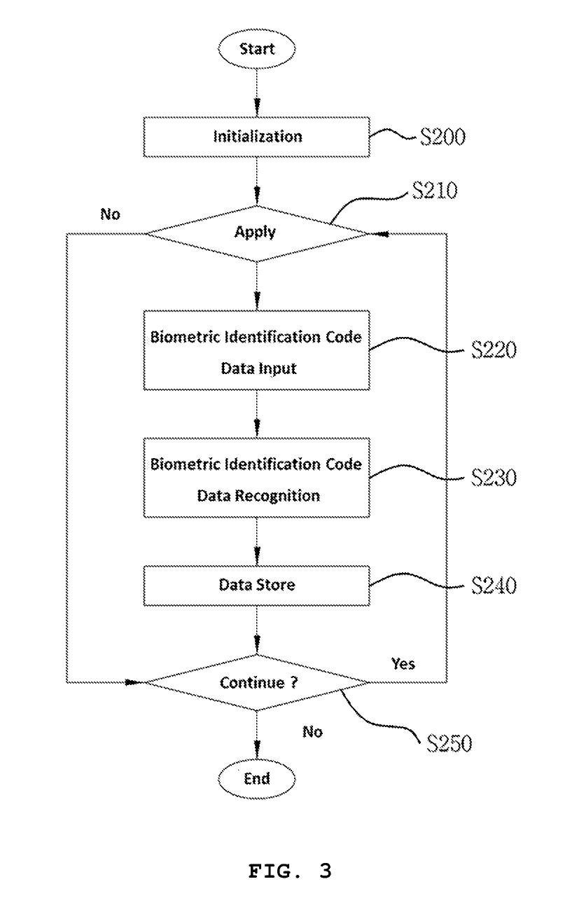

FIG. 3 is a flow chart for inputting biometric information of a mobile phone real-time shared security management system according to the present invention. Referring to FIG. 3.

Initializing the input units (S200) mounted on the mobile phone, and requesting the input unit of the mobile phone to input biometric information or identification codes (S210). After passing through the application step (S210), the biometric/identification code data input (S220) can be performed using input terminals such as a keypad, a camera, or a touchpad, which are various input units of the cellular phone. The unnecessary biometric information or the identification code generated in the biometric/identification code data input step (S220) is immediately deleted, the data suitable for the standard is recognized, and data such as biometric information or identification codes is stored. Finally, the process ends after the step (S250) of asking whether another biometric information or an identification code as described above is inputted.

As described above, the communication between the mobile phone and the separate independent management system is performed instantaneously using wired or wireless communication, and the independent management system separate from the mobile phone is protected by the stronger security than the existing technology by the Thummin system.

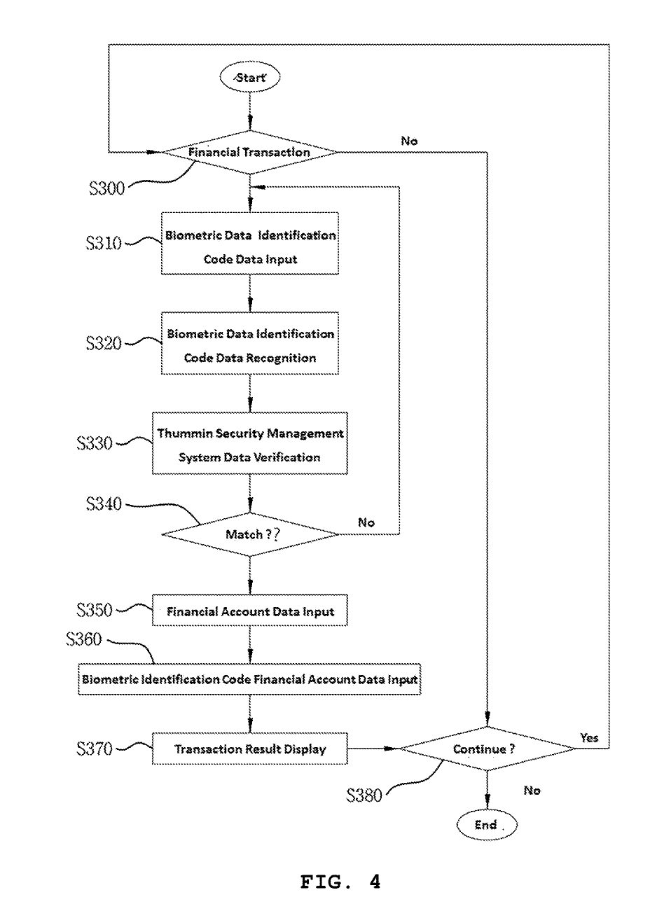

FIG. 4 is a flowchart for inquiring biometric information and financial information of a mobile phone real-time shared security management system according to the present invention. Referring to FIG. 4.

When the financial transaction with the financial company is performed using the thummin system 1, step (S310) of inputting the biometric information or the identification code of the user using the mobile phone after the inquiry of the continuation of the financial transaction (S300), (S330) of checking the biometric information or the identification code of the user stored in the biometric identification code data storage unit 12 through the step (S320) of recognizing the biometric information or the identification code as data, (S350) of inputting personal financial account data of the user using the mobile phone (S350) and a biometric/identification code/financial data inputting step (S360). When the above step has been performed, the transaction result is displayed on the user's mobile phone immediately (S370). As a result, the user inputs the biometric information of the individual, the identification code, and the financial information necessary for the financial transaction as data through the thummin system (1).

Such a series of steps is carried out instantaneously by using wired or wireless communication between the mobile phone and the separate independent management system, and the independent management system separate from the mobile phone described above is enhanced by the thummin system being more strongly protected.

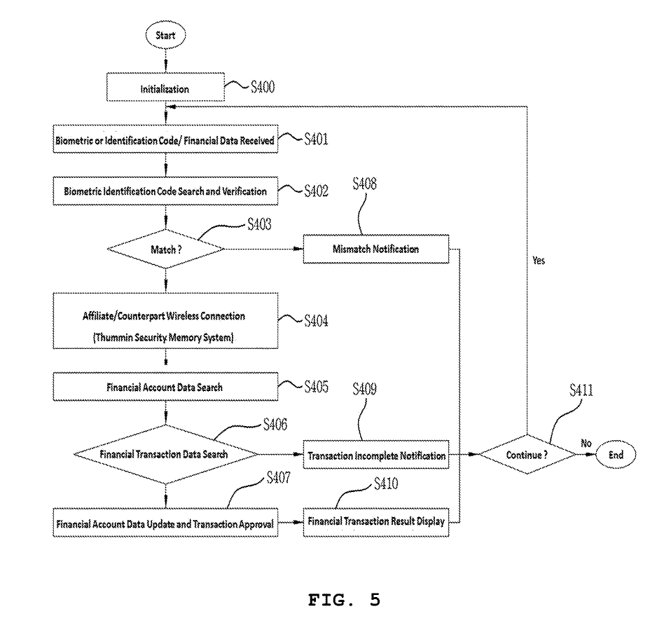

FIG. 5 is a financial transaction flowchart of a mobile phone real-time shared security management system according to the present invention. Referring to FIG. 5.

The bio-identification code/financial transaction data is received (S401) in the mobile phone through the initialization of the input device such as a mobile phone (S400). Step (S402) through the cellular phone, which is a component of the thummin system (1), and verifies the biometric information or the identification code of the individual (S403). At this time, if a mismatch determination is received, an identity mismatch notification is performed (S408) through the display unit of the mobile phone. When the mismatch determination is received, step (S404) wireless interaction is performed between the franchisee and the mating terminal. If it is impossible to inquire the financial transaction data at this time, it is notified that the transaction can not be performed (S409). If it is possible to inquire the financial transaction data, the data update and transaction approval step (S407) is performed, and the financial transaction result is simultaneously displayed on the mobile phone of the user and at the same time, affiliated terminal or the counterpart terminal (S410).

The present invention is not limited to the above-described embodiments. Anything having substantially the same constitution as the technical idea described in the claims of the present invention and achieving the same operational effect is included in the technical scope of the present invention.

### INDUSTRIAL APPLICABILITY

The present invention relates to real-time shared security management system for mobile phones, in which a main storage device (memory) of a mobile phone that is a separate independent system and linked to a real-time shared security system in a computer, (PG: Payment Gateway) by implementing e-banking transactions (incoming, outgoing, remittance, and debit and credit transactions) through wireless communication linkage and VAN companies. It is an innovative invention that does not require a high fee to VAN companies. Therefore, it is possible to receive support from most merchants because individual ID and password are not required. An essential technology for financial transactions used in mobile phones in the digital age. It is a technology required by agents, credit card companies, card merchants, etc., a useful technological innovation that can be utilized in industry sectors such as trade transaction, financial transaction, payment transaction process and the like.

What is claimed is:

1. Biometric/identification code data input unit 10 for inputting biometric information or an identification code of a user using a cellular phone;
Biometric/identification code data recognition unit (11) for recognizing the biometric information or the identification code of the inputted user;
Biometric/identification code data storage unit 12 for safely storing biometric information or identification codes recognized according to the standard;
Biometric information, an identification code and financial transaction data transmission unit 13 for transmitting biometric information or an identification code or financial transaction data of the user;
Biometric/identification code data receiving unit 14 for receiving biometric information or an identification code or financial transaction data of the user;
A biometric identification code for recording biometric information or an identification code or financial transaction data of a user in a storage unit;
A financial account data input unit 20 for inputting financial information of a user using a mobile phone;
Recognizing the financial information of the received user financial account data recognition unit 21;
A financial transaction data storage unit 22 for safely storing and storing the financial information data recognized by the financial account data recognition unit 21;
Financial transaction result data transmitting unit 23 for transmitting the processed financial transaction result to the user;
A financial transaction data receiving unit (24) receiving the processed financial transaction data by a mobile phone;
A financial transaction data inquiry unit 25 for inquiring a user's financial transaction;
The financial transaction result data receiving unit receives the processed financial transaction result from the mobile phone (26);
A financial transaction result display unit (27) displayed on the user's cellular phone;
And a financial transaction approval unit (28) for approving the financial transaction requested by the user.

2. In regards to claim 1,
The communication between the cellular phone constituting the thummin system (1) and the independent management system is interlocked in a wired or wireless manner and the range of the user's authority is determined by collating the biometric information of the user inputted with the cellular phone and the identification code in an independent management system real time shared security management system for mobile phones.

3. In regards to claim 1,
The mobile phone number and the identification code are encrypted and transmitted when financial transaction is performed using the thummin system (1), identity of the user is verified, and real time read out through an independent management system.

4. In regards to claim 1,
A mobile phone real-time shared security management system which that a financial transaction is performed by a direct financial transaction between individuals in a wired or wireless environment between an individual and an affiliate using the thummin system (1).

5. In regards to claim 1,
Features a real-time shared security management system for mobile phones. Automatically assigns an identification number or an identification code to a management system separate from the mobile phone constituting the thumumin system 1 and automatically delete commands added from the outside computer, IoT, robot, automated automobiles.

6. In regards to claim 1,
A real time shared security management system for mobile phones, characterized in that the user checks and compares the intelligent countermeasures, which randomly asks for various personal information when the user uses the thummin system (1).

7. In regards to claim 1,
When the user's cellular phone is lost or stolen, the cellular phone operates the alarm function on the cellular phone at the request of the user or operates the cell phone's location tracking function.

8. In regards to claim 1,
When the battery standby time and the usage time are extended by the design of the user, it is possible to extend mobile phone standby time and usage time with this independent management system.

9. In regards to claim 1,
When financial transaction is made using thummin system (1), especially, when a financial transaction is made using the camera, a face of the person using the camera of the mobile phone and the related information are stored in an independent management system.
